(19) United States
(12) Patent Application Publication
(10) Pub. No.: US 2007/0084542 A1
(43) Pub. Date: Apr. 19, 2007

(54) Process and apparatus for forming stretched paint films and articles formed using same

(75) Inventors: John C. Montagna, Metamora, MI (US); Russell L. Herlache, Saginaw, MI (US); Carlito Soria, Lake Orion, MI (US); Gary Nehring, Linden, MI (US)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: Durakon Industries, Inc., Lapeer, MI (US)

(21) Appl. No.: 11/253,409

(22) Filed: Oct. 19, 2005

(51) Int. Cl. B32B 27/20

(52) U.S. Cl. 156/160; 428/411.1; 428/910; 428/31

(57) ABSTRACT

Described herein is a process for manufacturing a part or a part pre-form, for example, a vehicle part or vehicle part pre-form, as well as articles of manufacture incorporating pre-stretched paint films and substrates such as extruded sheet. Also described herein is an apparatus useful for the process described, which process includes providing a paint film having a length as measured along a longitudinal axis of the paint film; continuously stretching the paint film in the transverse and/or longitudinal directions of the film over the length of the paint film to form a pre-stretched paint film; and applying the pre-stretched paint film to a thermoformable substrate to form a part or part pre-form.

### BACKGROUND OF THE INVENTION

Instead of spray painting certain parts in the manufacture of automobiles and other moving vehicles, it is known to use decorative films, referred to in automotive manufacturing as paint films, which are flexible, stretchable, pigmented thermoplastic films. Such films typically include a carrier, a decorative or pigmented layer and a protective coating, and may further include optional adhesive and other layers as well. Such films are manufactured and sold for a wide variety of uses and come in standard or “stock” sizes. In automotive manufacturing, such films are typically applied using known vacuum thermoforming techniques. Typically, the paint film is placed in a stretcher frame of some sort and heated and stretched during the thermoforming process.

The use of paint films is beneficial in that it eliminates or minimizes certain disadvantages associated with use of spray painting, e.g., evaporation of solvents and removal of liquids containing excess paint and/or solvents. Paint films can also be used to provide smooth and attractive surfaces to the finished part; however, obtaining defect-free parts is not always achievable. Further, difficulties are encountered in the degree of stretch or deformation that occurs in vacuum thermoforming as described in U.S. Pat. No. 4,838,973 of Mentzer. In that patent, a paint film is placed in a tenter frame and heat-softened and lowered onto a substrate to be coated during the thermoforming process.

Another limitation on the use of paint films is that they come in only certain sizes. For larger parts, such paint films are not adequately sized and/or would need to be specially manufactured at great expense, rendering use of such techniques for larger parts not sufficiently economically practical. While some stretching of such films does occur in the thermoforming process, it is more on the nature of a softening or “sag” which allows for the two-dimensional film to be applied to a three-dimensional part. Further, such stretching occurs in discrete applications of a cut piece of film to an automotive pre-form part during actual thermoforming of the part.

It is also known that the paint film manufacturing industry is currently limited with respect to sheet width. The widest width known to be available approaches approximately sixty inches. Such size limitations occur for various reasons, among which is the greater expense needed to make paint film stock of widths greater than available since, among other things, the application of paint film to form the stock is carried out by a gravure process. As a result, many wide products, for example, tonneau covers, are not generally made with prior paint film technology.

U.S. Publication No. 2005-0023729-A1 was proposed to address such shortcomings and describes pre-stretching of standard paint films using a tenter frame type apparatus to enable use of standard paint films for larger sized parts. However, the tenter frame requires a separate step and pre-cutting and sizing of the paint film.

There is a need in the art to expand the use of such paint films for environmental and manufacturing safety reasons, while maintaining the economic feasibility of such processes in automotive and other types of vehicle part manufacture. It would further be advantageous to be able to adapt standard size paint films for use on larger parts, in an economical manner using in a more automated and efficient process.

### BRIEF SUMMARY OF THE INVENTION

The invention includes a process for manufacturing a part or a part pre-form. The process comprises (a) providing a paint film having a length as measured along a longitudinal axis of the paint film; (b) continuously stretching the paint film over the length of the paint film to form a pre-stretched paint film; and (c) applying the pre-stretched paint film to a thermoformable substrate to form a part or part pre-form.

An article of manufacture is also within the scope of the invention herein and in one embodiment comprises (a) a thermoformed substrate having a first surface and a second surface; and (b) a pre-stretched paint film laminated to at least one of the first and the second surface of the thermoformed substrate, wherein the pre-stretched paint film is formed from a paint film having a width as measured generally perpendicularly to a longitudinal axis of the paint film which is no greater than about 153 cm which has been stretched in a direction which is parallel to and/or perpendicular to the longitudinal axis of the paint film so as that it will approximate a size of the thermoformed substrate after thermoforming.

An article of manufacture is also included which is one embodiment comprises (a) an extruded sheet capable of forming a part or part pre-form and having a first surface and a second surface; and (b) a pre-stretched paint film applied to at least one of the first and the second surface of the extruded sheet, wherein the pre-stretched paint film is formed from a paint film having a width as measured generally perpendicularly to a longitudinal axis of the paint film which is no greater than about 153 cm which has been stretched in a direction which is parallel to and/or perpendicular to the longitudinal axis of the paint film so as that it will approximate a size of the extruded sheet.

The invention also includes an apparatus for pre-stretching a paint film, which comprises (a) a paint film feed roll; (b) a continuous stretching station comprising a continuous drive mechanism and a plurality of grippers located on a first side and a second side of the stretching station and which are capable of stretching a paint film in a direction generally perpendicular to a longitudinal axis of a paint film, wherein the continuous drive mechanism activates the plurality of grippers; (c) a pre-stretched paint film take-up roll; and (d) at least one heat source.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic diagram of an embodiment of the process and apparatus described herein;

FIG. 1A is a schematic diagram of another embodiment of the process and apparatus described herein;

FIG. 2 is an enlarged cross-sectional view of a preferred paint film for use in one embodiment of the process described herein taken along line 2-2 in FIG. 1A;

FIG. 3 is a perspective view of an article of manufacture according to an embodiment described herein;

FIG. 4 is a cross-sectional view of an enlarged portion of the article in FIG. 3 taken along line 4-4;

FIG. 5 is an enlarged partial top perspective view of a portion of a stretched paint film exiting the chain drive section of the continuous stretching station of an embodiment of the apparatus of FIG. 1;

FIG. 6 is a perspective view of a further article of manufacture according to an embodiment described herein; and

FIG. 6A is an enlarged cross-sectional view of the article of FIG. 6 taken along line 6A-6A.

### DETAILED DESCRIPTION OF THE INVENTION

Certain terminology is used herein for convenience only and is not to be taken as a limitation on the present invention. The words “right,” “left,” “outwardly,” “inwardly,” “top” and “bottom” designate directions in the drawings to which reference is made. The terminology includes the words above specifically mentioned, derivatives thereof, and words of similar import.

Described herein are a process for manufacturing a part or a part pre-form, for example a preferred embodiment such as a vehicle part or a vehicle part pre-form as well as articles of manufacture such as vehicle parts and vehicle part pre-forms and an apparatus useful for the process described herein. It should be noted that while the preferred embodiment described herein refers to formation of vehicle parts and vehicle part pre-forms, the invention described herein may also form parts and part pre-forms for use in home construction, electronics products, consumer goods and in any other application in which paint films may be used. The detailed description provided herein for the purposes of convenience will describe the invention in terms of the preferred vehicular embodiment for the purposes of convenience only, however, the detailed description herein should not thereby be considered to be limiting to the scope of the invention and other uses and end applications of the invention.

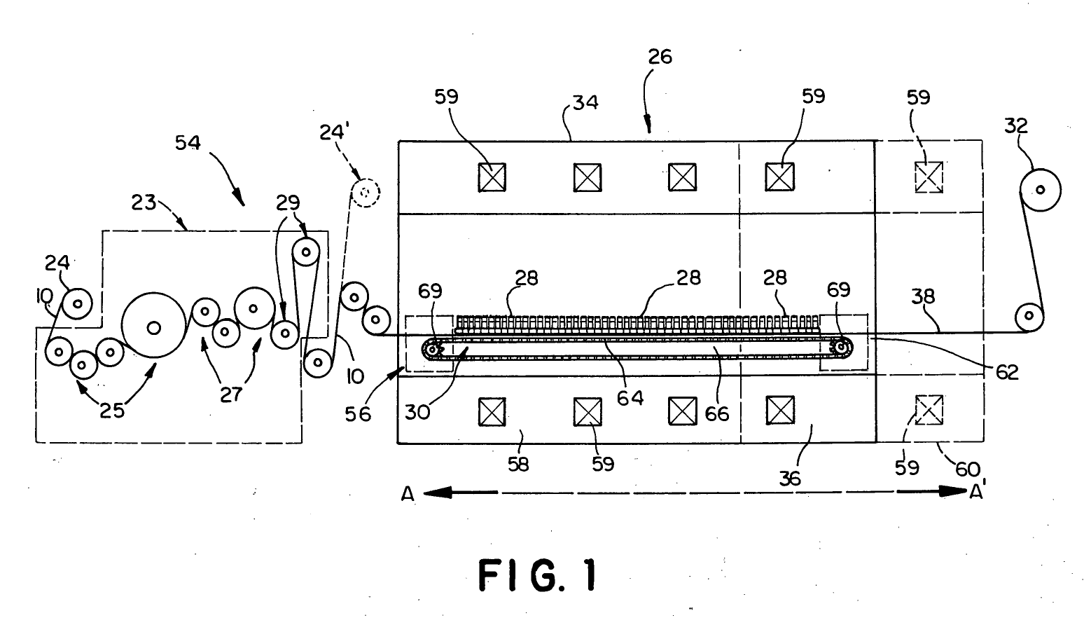

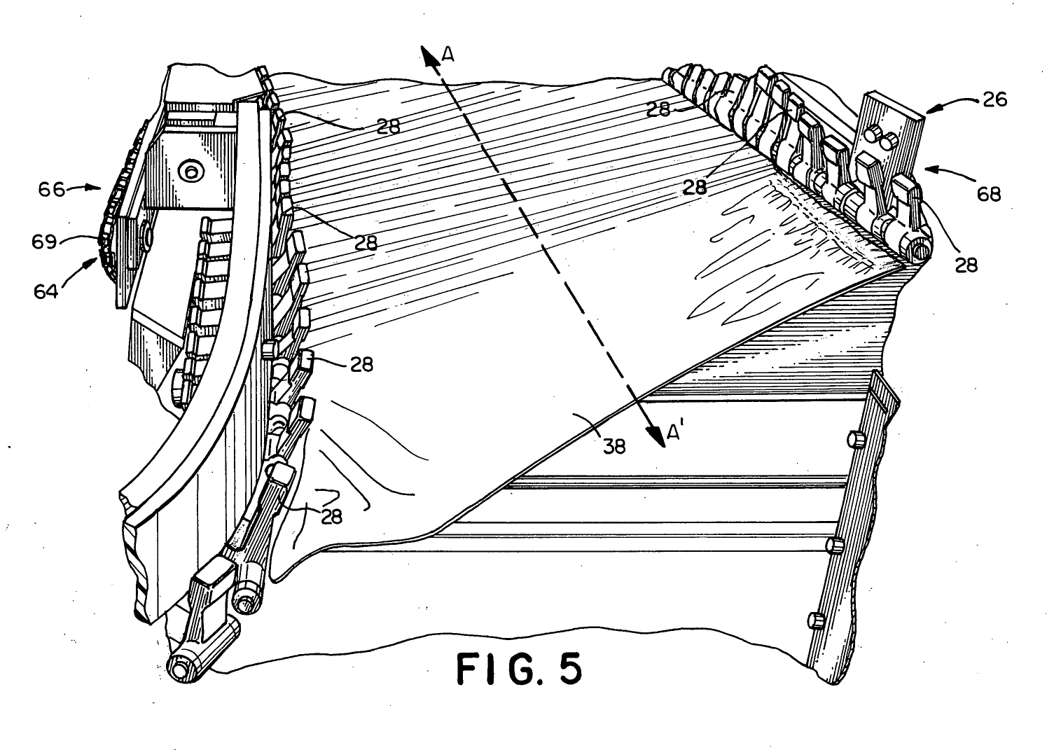

The process includes providing a paint film, such as the paint film generally designated as 10 which has a length measured along a longitudinal axis A-A′ of the paint film 10 as shown in FIGS. 1 and 5. The paint film is preferably, but need not be, provided in the form of a roll capable of being unwound for stretching. The paint film 10 may be any suitable paint film capable of being used in a thermoforming process. Such paint films are also known in the art as decorative films, and the use of the term “paint film” as used in the automotive, vehicular or other manufacturing industry is meant to include all such films having a carrier, at least one pigmented or other decorative layer and preferably a protective coat. Such films are commercially available or may be manufactured to have desired properties or to provide specific visual effects. Since it is preferred herein that standard or commercially available paint films known for use in the automotive and/or other vehicle manufacturing industry are used for efficiency and economical reasons, it is preferred that the paint films used herein have a width as measured in the generally transverse direction, i.e., generally perpendicularly to the longitudinal axis of the paint film which is no greater than about 60 in. (153 cm). However, it will be understood based on this disclosure that if specialty films of greater widths are used (or in the future, standard films have wider widths), that wider films may also be used and stretched in accordance with the process described herein.

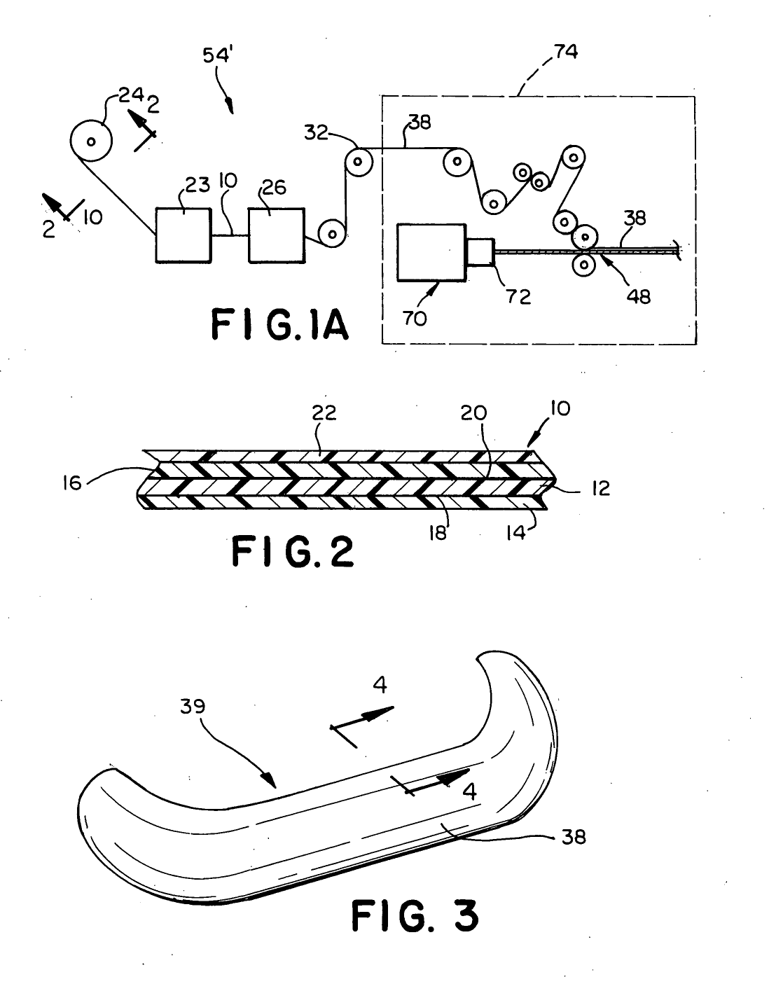

The paint films used herein preferably include a carrier layer which is thermoformable. As shown in FIG. 2, a paint film 10 preferably has a carrier layer 12 which may have an optional layer shown in FIG. 2 which is an adhesive or adhesion promoter layer 14. The adhesive layer is optional because different methods for applying the paint film for lamination in vehicle parts or part pre-forms may be used, including applying the films using a pressure and/or heat-sensitive adhesive layer. The carrier layer 12 is preferably thermoformable so that it will be useful in the typical thermoforming processes used to make vehicle parts and pre-forms. However, the paint film 10 to be used may be purchased commercially with a non-thermoformable carrier (such as Mylar®) provided that the carrier is preferably replaced with a thermoformable carrier prior to stretching. Suitable carriers are those which have properties that allow them to deform and perform successfully in typical thermoforming processes. The carriers may be transparent, opaque or pigmented preferably consistently with any other decorative or pigmented layers.

Preferred carrier layers include but are not limited to polyvinyl chloride (PVC) films, polyvinyl acetate (PVA), acrylonitrile-butadiene-styrene (ABS), polystyrene (PS), polyethylene (PE), polypropylene (PP), thermoplastic polyurethanes (TPU), polyvinylidene fluoride (PVDF), polyvinyl fluoride (PVF), polyarylates, elastomeric styrene-maleic anhydrides, polycarbonates, polyetheresters, and uniaxially and biaxially oriented polyesters (e.g., Melinex® 314 and Melinex® 454 available from DuPont) as well as copolymers, blends, alloys and combinations of the foregoing thermoplastic polymers. Most preferred for use with the invention herein are PVDF and TPU. Such films may also include various additives associated with manufacture of such carrier films such as fillers, UV absorbers, plasticizers, colorants, antioxidants and the like.

As noted above, the carrier layer may include optionally an adhesive or adhesive-promoting layer, which may be either a pressure sensitive and/or a heat sensitive adhesive layer and/or an adhesion promoting layer to assist in application of the paint film once stretched in accordance with the process described herein to a substrate which may be a preformed part or a pre-form for a vehicle part that will later be thermoformed into a desired part. Such adhesives may be any such adhesives that will perform under the process conditions and/or which are known in the art for similar uses. If an adhesive or adhesion promoting layer 14 is used, it should be on a surface 18 of the carrier 12 that is opposite the surface 20 on which any pigmented or decorative layer 16 is placed.

The decorative or pigmented layer 16 may be applied directly to a surface 20 of the carrier layer 12 or it can be adhered to the carrier layer 12 through an optional tie layer (not shown) as is known in the art. The decorative layer may be formed in accordance with any known or to be developed techniques known in the art, provided that the decorative layer functions adequately in processes generally used in forming vehicle parts or vehicle part pre-forms. For example, the decorative layer may be a single pigmented layer or a series of such layers to provide a desired decorative effect. The decorative layer may also include metallic flake or other fillers known in the art for visual effects when forming vehicle parts or part pre-forms. Suitable pigments and/or colorants for use in the decorative layer(s) 16 include organic colorants such as various known blue, green, yellow, violet, red, orange and other types of dyes, related chromophores and combinations and mixtures thereof, and inorganic pigments such as titanium dioxide, iron oxide, chromic oxide and other metal oxides, lead chromate, carbon black, silica and silica compounds, talc, clay, and ceramics and combinations and mixtures thereof. The decorative/pigmented layer 16 may also include and/or include as an alternative, metallic flakes or other particles for forming a reflective look, including glass, mica, metallic coated polymer, and metallic materials in particle or flake form including, for example, stainless steel, aluminum, copper, bronze, nickel, magnesium, zinc, titanium, tantalum, palladium, platinum, gold, silver and alloys thereof. Such materials can be used alone or in combinations to provide desired effects. In addition, the decorative layer 16 may be a solvent or non-solvent based layer and may include standard binders, additives and/or solvents which are known for use in decorative films and/or to be developed, including the preferred use in the vehicle part field such as fillers, binders, UV absorbers, and film-forming agents, flatting agents, thixotropic agents, extenders, dispersants, leveling agents, wetting agents, adhesion promoters and pigment stabilizers.

The film 10 also preferably includes a protective layer 22 also known as a clear coat or lacquer coat that is preferably suitable for use in vehicle part or vehicle part pre-form manufacture. The protective layer 22 can be used to protect the film from scratching, impact damage, staining and/or UV light damage. The protective layer may be solvent-based or non-solvent based, and may include materials such as, but not limited to acrylates, acrylic polyols obtained by copolymerizing a hydroxy-functionalized acrylic monomer with an alkyl acrylate, methacrylate and/or styrene monomer. Preferably, such layers also include reactive cross-linking resins, any necessary catalyst and/or silicone or functionalized silicone such as a hydroxy-functional polyester-modified dimethylpolysiloxanes and similar silicones. The protective layer preferably includes either generally known curable lacquers such as an EB- or UV-curable protective lacquer, or a two-component polyol/polyisocyanate system including components such as crosslinkable polymeric polyols (such as a polyester polyol, polyurethane polyol or acrylic polyol) in combination with a polyisocyanate or other crosslinking agent. Other additives may also be provided to the protective layer 22, such as the additives mentioned above as well as defoamers, extenders for enhancing scratch resistance and pigments for adjusting gloss level if necessary.

Solvents which may be used in forming such paint films in the decorative, adhesive and/or protective layers include water or any organic solvent having compatibility with the thermoplastics, resins or lacquers selected for the particular layer, for example, acetone, diacetone alcohol, ethanol, toluene, xylene, butyl acetate, ethyl acetate, ethylbutyl acetate, methyl ethyl ketone, methyl isobutyl ketone, isopropanol, methylpyrrolidone, cyclohexanone, glycol ethers and the like, and mixtures and blends thereof. It will be understood by one skilled in the art based on this disclosure that the appropriate solvent(s) should be chosen with regard to its compatibility with those resins which are used in the formulations of the various layers of the paint film 10. Factors such as intended end use, type of carrier film 12 and/or resins used, resin solubility, potential toxicity, and boiling point should be considered in selecting appropriate solvents.

It is preferred that in any paint film 10, that solvents are present in an amount that allows for adequate properties to be achieved, but which minimizes the presence of volatile organic compounds (VOCs). The preferred paint films used in the present invention are commercially available from, for example, Soliant, Avery Dennison, Dorrie, 3M, Nissha, Leonhard Kurz GmbH & Co., Inc., Kurz-Hastings, Inc., Dainippon, Shinetsu and other commercial sources.

The process includes continuously stretching the paint film either in the machine direction of orientation (MDO) which is generally parallel to the longitudinal axis of the paint film and/or in a direction generally perpendicular to the longitudinal axis of the paint film, i.e., the transverse direction of orientation (ITDO) over the length of the paint film to form a pre-stretched paint film. The pre-stretched paint film is applied to a substrate, which is preferably thermoformable so as to form a vehicle part or vehicle part pre-form.

As shown in FIG. 2, as the paint film 10 is supplied from a roll or rolls, such as representative feed roll 24 as shown. In the beginning of the process, the paint film may be stretched in the MDO direction in an MDO stretching section 23 shown by the dotted section by using a series of rollers. A first series of opposing rollers 25 can be used with one roller having a softer elastomer for traction and another of polished steel in which heat can be provided to provide some pliability to the film. A second series of opposing rollers 27 can also be used similar to the first set, but running at a speed which is somewhat faster than the first set of rollers so as to apply tension to the paint film 10 to cause stretching in the MDO direction. The material may be cooled by cooling roller(s) 29. Thus, an MDO stretching section 23 may be formed in advance of feeding the film to a continuous stretching station 26, in which a first series of rollers 25 heat and grip the incoming film 10 from the feed roll 24 and the second set grip and stretch the material in the MDO direction by speed differential. After such MDO stretching, the film can be wound on a separate feed roll 24′ or fed directly into the continuous stretching station 26. The MDO stretching section 23 is in a dotted lined section because it is optional. In the present process, the MDO section 23 can be omitted and the feed roll 24 used to supply the paint film directly to the continuous stretching section with MDO stretching provided, if desired, using a speed differential or other tensioning method applied to the feed roll and/or take-up roll at the end of the process.

In the continuous stretching station 26 there are a plurality of grippers 28 driven by a chain drive mechanism 30 that guide the paint film 10 in a continuous manner in the longitudinal direction. As the paint film travels, the grippers and chain drive stretch the paint film in the transverse TDO direction. As the film is removed from the stretching station 26, it is preferably re-wound on a take-up roll 32. The take-up roll 32 can also function as a feed roll or with a further feed roll in the event that the stretched film is going to be applied directly to an extruded sheet or other substrate as shown in FIG. 1.

While passing through the continuous stretching station 26, one or more standard heating units can be used such as those typically used for pre-heating paint films. The heating units can be applied to soften the film as it passes through the stretching station. Preferably, as shown in FIG. 1, the heating unit(s) is in the form of a multi-zone heating chamber or oven 34 that encloses the stretching station, however, it will be understood that individual heaters, blown hot air or other similar heating elements may be used.

It is preferred that while passing through the stretching station 26, the paint film is maintained at a speed of from about 10 to about at 40 feet per minute, preferably about 20 to about 30 feet per minute, and most preferably about 25 feet per minute. The oven includes at least one zone in which heat is applied for pliability and the preheated oven zone is set at about 250° F. to about 400° F., more preferably from about 275° F. to about 325° F., and most preferably about 300° F. The heat need only be applied as a pre-conditioning of the film, i.e., at the outset of the stretching process, but can also be applied along the length of the stretching path if desired. At the end of the continuous stretching station or, more preferably, after stretching is finished, the film is preferably passed through an annealing zone 36 in the oven in the continuous stretching station 26 in which the film is oriented, preferably post-stretching, at a preferably somewhat lower temperature than the heating zone of the oven, and preferably from about 225° F. to about 350° F., more preferably from about 250° F. to about 300° F. and most preferably about 260° F. The film is then cooled and upon exiting the stretching station, the film is preferably about ambient temperature. Cooling may be undertaken by way of example, through the use of cooling air jets, chill rolls or simply air cooling. Cooling can take place in a third, cooling zone of the oven or heating chamber, through use of cooling rollers or through use of an ambient air section.

In the preferred embodiment of the process described herein, tensioning is applied in the take-up roll(s) 32 which can be adjusted to provide MDO stretching of the paint film 10 in the longitudinal direction and if desired, in the transverse direction for providing a biaxial stretch to the paint film. If desired, biaxial stretching can also be accomplished if an MDO stretching section is used as mentioned above. While not necessary, the tensioning also helps align the film and maintain process speed, avoiding equipment malfunction or bunching of the film during take-up. The take-up speed and tension can be adjusted using any standard take-up roll apparatus known in the film arts and can be set for varying process desired end film effects.

Unlike in prior applications of using paint films during a thermoforming process, a higher pigment loading in the initial film is not necessary provided reasonable stretching limits are being used. For example, to thermoform a vehicle part that will need to undergo an extensive amount of forming or draw, it would be desirable to limit the degree of pre-stretching applied in the process for forming the vehicle part pre-form so that the pre-stretched film does not get too thin during thermoforming. Using standard paint film and in view of resulting gloss and appearance levels, use of the present process provides no significant change across the range of stretching from about 25% to about 300% in width of the original paint film. Based on different contours and three-dimensional effects desired in thermoformed parts, the pre-stretched paint film may stretch further during thermoforming at different amounts within the mold. The depth to which the paint film has to be drawn in the mold will limit the degree to which the pre-stretched paint film can be further stretched.

Once the film exits the continuous stretching station 26, in the form of a pre-stretched paint film 38, the pre-stretched paint film 38 can then be unrolled from the take-up roll for direct, continuous application onto a substrate such as an extruded sheet as shown in FIG. 1 or send to any acceptable cutting station (not shown) in which the pre-stretched paint film can be cut to a desired, predetermined length as measured along the longitudinal axis of the paint film to form pre-stretched paint film sheets. Such size can be pre-cut to approximate the size of the intended substrate (such as an extruded sheet). The paint film sheets as cut can be applied using any suitable technique (film wrapping machine, adhesive or heat lamination, press stamping, vacuum forming, thermoforming, insert molding, etc.) to a substrate preferably an extruded thermoplastic sheet or the like useful for forming vehicle parts or pre-forms. If continuously applied to a substrate, the pre-stretched paint film can be applied using an adhesive or hot rolling to a substrate, or directly applied to an extrudate that is still sufficiently hot so as to be compression laminated using rolls or similar techniques to the paint film. Once applied, the substrates having the pre-stretched films applied thereto can be used as is as a vehicle part pre-form or similar article of manufacture, or more preferably, cut to size and used in a thermoforming process or any other acceptable heat molding process to form other articles of manufacture including vehicle parts or vehicle part pre-forms. While thermoforming is preferred, it should be understood by one skilled in the art based on this disclosure, that such pre-stretched paint films could be used in other molding applications, such as, but not limited to extrusion, injection or compression molding or simply the application of decorative films on appropriate and compatible substrates by a process such as hot stamping and that reference to thermoforming herein should not be considered to be limiting to the scope of the invention.

Any suitable thermoforming process may be used, however, it is preferred that vacuum thermoforming is used. In such a process, the pre-stretched sheet either already applied to a thermoplastic substrate such as an extruded sheet or separately applied during the thermoforming process to such a substrate is placed over a shaped forming surface. Heat and vacuum are applied within the mold to draw and shape the substrate over the shaped surface. The part is then cooled to form a vehicle part.

The term “vehicle part” as used herein includes a part useful in making vehicles, including without limitation trucks, automobiles, motorcycles, farm vehicles and equipment, four- and three-wheel all terrain vehicles, bicycles and related non-motorized vehicles, scooters, mopeds and the like. The term “vehicle part pre-form” includes any article of manufacture that may be used for further processing of any type which results in a vehicle part. As noted above, a “part” may be any part useful form making articles of manufacture sold in any of a variety of industries, including automotive, construction, electronics, consumer goods and others. The term “part pre-form” includes any article of manufacture which may be used for further processing of a type which results in a “part.”

In application of the pre-stretched paint film 38 to a substrate, it should be understood that the substrate may be any substrate suitable for receiving a paint film (wood, middle density fiberboard, chip board, particle board, oriented strand board, thermosetting and thermoplastics, glass, silicon-based materials, ceramics and the like, provided that the adhesive system and/or decorative layer(s) are adjusted for use on such substrates). However, for use in forming vehicle parts and vehicle part pre-forms, it is preferred that the substrate be a thermoformable and/or injection moldable substrate such as, but not limited, to polyethylene (including high density polyethylene), polypropylene and other polyolefins, poly(acrylonitrile-butadiene styrene), poly(styrene-acrylonitrile), polyacetals, polyacrylics, polyamides, polyphenols, polycarbonates, polyesters, polypropylenes, polystyrenes, polyurethanes, polyvinyl chlorides, polyesters including polyethylene terephthalates, polyvinyls, polyphenylene oxides, polyphenyleneesters, polyphenyleneetheresters, polyetheresteres, polyphenylene sulfides, polyarylenes such as polyether ketones, polyetherether ketones, polyetherketone ketones, fluoropolymers (such as thermoplastic TFE-based copolymers such as PFA and FEP), polyvinylidene fluoride, polyvinyl fluoride, thermoplastic elastomers, and copolymers, alloys, blends and derivatives of these materials with each other and with other monomers, polymers, and including fillers and/or reinforcing agents. In addition, it is also acceptable to use elastomeric (vulcanizable or vulcanized) materials and/or to have a substrate which is filled or unfilled with various additives typically used in a given industry, such as the vehicle part industry, including pigments, glass, ceramic, mesh, honeycomb, mica, clay, organic colorants, plasticizers, thixotropic agents, flame retardants, UV absorbers, extenders, stabilizers and the like.

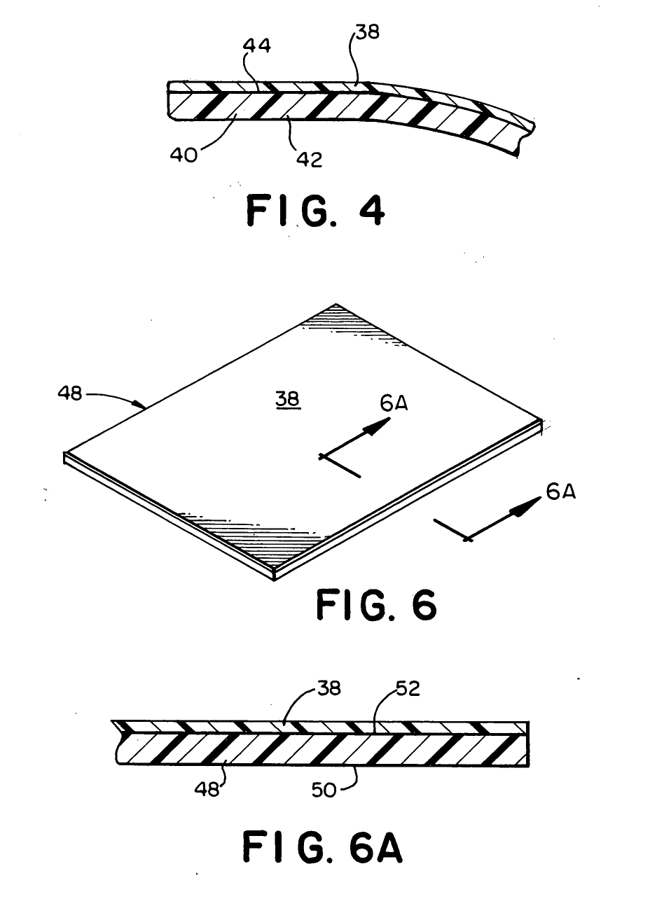

Also included within the scope hereof is an article of manufacture 39 as shown in FIGS. 3 and 4, represented generically by an automotive bumper that includes a thermoformed substrate 40 having a first surface 42 and a second surface 44. The article further includes a pre-stretched paint film 38 that is laminated to the second surface 44 of the thermoformed substrate. It should be understood that the pre-stretched paint film 38 could be laminated to both the first and second surfaces, 42, 44; however, it is optional depending upon design. The pre-stretched paint film 38 is preferably formed in accordance with the paint film 10 described above. It preferably is derived from a standard, commercially available paint film having a width as measured generally perpendicularly to a longitudinal axis of the paint film which is no greater than about 60 in (153 cm). The paint film should be stretched in the MDO and/or TDO directions in accordance with the process described herein to have a size that will approximate the width of the thermoformed substrate after the thermoforming process is completed. Preferably, the pre-stretched paint film 38 has been stretched biaxially using the preferred process noted above.

The article of manufacture can be any vehicle part or vehicle part pre-form, including a bumper, a running board, a door, a body panel, a cargo box, a tonneau cover, a fender, a truck bed liner, a car hood and the like.

Also within the scope of the invention is an article of manufacture 46 that includes an extruded sheet 48, preferably a thermoplastic sheet which is capable of forming a vehicle part or vehicle part pre-form. Such an article is shown in FIG. 1A and FIG. 6 and in cross-section in FIG. 6A. The extruded sheet has a first surface 50 and a second surface 52. A pre-stretched paint film, preferably the pre-stretched paint film 38 described herein is applied to the second surface 52 of the extruded sheet 48. However, it should be understood from this disclosure, that the paint film 38 may also be applied to both surfaces 50, 52. The pre-stretched paint film 38 is preferably any of the paint films described herein and is more preferably a standard commercially available film of standard width as measured generally perpendicularly to a longitudinal axis of the paint film which is no greater than about 60 in. (153 cm). The pre-stretched paint film 38 has been preferably stretched in the MDO and/or TDO directions so as to have a size that will approximate the width of the extruded sheet.

The pre-stretched paint film 38 may be applied using any standard lamination technique including direct application to the heated extrudate sheet, use of an adhesive, hot press, or other similar techniques.

An apparatus 54 is shown in FIG. 1 for pre-stretching a paint film such as paint film 10. The apparatus includes a paint film feed roll or rolls such as roll 24 for unwinding a roll of paint film for feeding the roll of paint film into a stretching station. The paint film prior to unwinding may also go through a series of alterations for use within the process, such as in the event the carrier must be stripped and replaced with a thermoplastic or otherwise stretchable carrier. If so, an additional series of rolls and stripping mechanisms known in the art may be used for such process. A thermoformable carrier film may be applied using adhesive or heat process application techniques.

Once the paint film with suitable carrier such as paint film 10 is drawn from the feed roll it can be passed through an MDO stretching section 23 as described above and/or enter directly into a continuous stretching station 26 which includes a feed section 56, a heating section 58, a cooling section 60 and an exit 62. Within the continuous stretching station is a continuous drive mechanism 30 which includes at least two chain drives 64 that run on a continuous loop from the feed section 56 to the exit 62. The chain drives 64 activate and operate a plurality of grippers 28. The chain drives 64 and grippers 28 are located on each of a first side 66 and a second side 68 of the continuous stretching station 26. As the chain drive mechanism passes along a pair of grippers, the grippers open to allow for clamping on the paint film 10 and then as the mechanism further passes, the grippers close onto and clamp down on the paint film 10. The chain drives 64 diverge from each other as they are continuously pulled along their track as they move toward the end of the chain drives such that the film is stretched generally transversely (TDO direction). As the grippers reach the end of the chain drive at the chain drive sprockets 69, the grippers 28 open to release the pre-stretched film so that it may be wound on the take-up roll. The chain drives may be operated by a separate motor and power source with controls or mechanically operated so as to be responsive to the roll pulling tension of the process without an additional power source or motor to operate the drive mechanism.

The continuous stretching station includes a heating section 58 that includes at least one heat source. As shown in FIG. 1, the heat source is a heating chamber or oven 34 which surrounds the chain drive mechanism and grippers such that the film can be heated either across the entire oven or in desired zones, such as for a preferred pre-conditioning heating at the outset of stretching followed by an annealing zone and a cooling zone. Alternatively, a constant temperature may be applied throughout the oven or in only a pre-conditioning section. The oven or other heating source(s) should preferably have individual zone control and the ability to apply heat and/or cool evenly on both sides of the paint film or to a greater degree on only one surface of the film if it is desired to heat the carrier to a greater or lesser degree than the protective layer during stretching using fans 59 or individually controlled units. Toward the end of the continuous stretching station, there is a cooling section 60. The cooling section may be enclosed within the chain drive area within the heating chamber/oven 34 and/or at the end of the oven within the continuous stretching station 26, or it can be placed outside the stretching station. It may include an ambient air section as shown, a chilled air section or a separate series of chilled rollers (not shown). It is preferred that the pre-stretched paint film 38 is cooled prior to rolling up the pre-stretched paint film on a take-up roll to avoid tackiness, however, it is also contemplated that a heated pre-stretched film is applied directly to a heated extruded sheet.

In one preferred embodiment, at the end of the heating section 58 and prior to the cooling section 60 but preferably after stretching, there is an annealing zone 36. The annealing zone should be separately set at a temperature of about 20° F. to about 50° F. less than the heating temperature for stretching. As the preferably cooled pre-stretched film exits the continuous stretching station, it is preferred that it is re-wound on a take-up roll or rolls such as take-up roll 32. A tensioner, such as by applying a speed differential between the feed and take-up rolls, using an additional pressure roll(s) or a pulling apparatus can be used to provide tension to the paint film throughout the process and further stretch the film in direction along a longitudinal axis of a paint film. As shown, the apparatus can be set to include a speed differential and/or to include a separate MDO stretching section 23.

Also as shown in FIG. 1A, in one preferred embodiment, the apparatus 54′ further includes an extruder station 70 having an extruder 72 for forming an extruded sheet such as extruded sheet 48. As an extruded thermoformable sheet (having one or more layers depending on whether an extruded or coextruded or multilayered sheet is being formed) exits the extruder, it receives the pre-stretched paint film on one surface of the extruder in an application station 74. An application station 74 may include any of a number of configurations either for applying the pre-stretched paint film to the substrate such as an extruded sheet. For example, the application station may include apparatus for providing a steady feed of adhesive using a nozzle and a doctor blade or the like; heat application of the film to the sheet using an already existing adhesive layer on the paint film; pressure application of the film to the sheet using rollers or the like to activate a pressure-sensitive adhesive already on the paint film; or combinations thereof. Alternatively, the application station may just use heat and pressure to allow the heat of the extrudate of the extruded sheet to adhere the paint film to the extruded sheet as shown when the film is fed to and laminated to the extruded sheet using pressure rollers. Regardless of the manner in which the pre-stretched paint film is applied, it is drawn using rollers or a similar mechanism from the take-up roll 32 and applied to the extruded sheet 48 from the extruder 72 in the extruding station 70 in the application station 74.

The invention will now be described further in reference to the following non-limiting Example:

### EXAMPLE 1

Two paint films were stretched in the machine direction (MDO) longitudinally. The film in both cases was, by way of example a PVDF base film supplied by Soliant. The stretching took place by preheating the film to 210° F. and subsequently stretching the film longitudinally by using differential roller speeds. The first film (Sample 1) was stretched 60% using 25% tension in the MDO direction. The second film was stretched 40% using 20% tension in the MDO direction (Sample 2). The films were pre-conditioned by heating to 210° F. and were run through the process at a film speed of 8 ft/min. The paint films exhibited no significant loss in color or gloss. For Sample 1, the initial gloss level was 82° and the final gloss level at 60% stretch in the MDO direction was 85°. For Sample 2, the initial gloss level was 82° and the final gloss level was between 82° and 84°.

### EXAMPLE 2

A series of paint films (Samples 3-10) were stretched in the TDO direction using varying degrees of desired TDO overall stretch and using a PVDF carrier paint film supplied by Soliant. The data for the width at 7 TDO width measuring stations and the TDO continuous stretching station exit is shown in Table 1 below as measured in inches. Table 1 also shows the exiting film thickness in mils (wherein 1 mil as used herein is equal to 0.0254 millimeters or 0.001 inches). The films were grey in color. An inlet width of 13 in. (33 cm) with a thickness of between 4.8 and 4.9 mils was used. The core size was 6 in. (15.2 cm), wherein the core is the paper tube on which the film was wound. The oven was set with three zones of heat set points: 300° F. (actual 302° F.) having a 600 rpm fan; 300° F. (actual 301° F.) with a 600 rpm fan; 260° F. (actual 261° F.) with a 600 rpm fan. A cooling fan at 800 rpm was also provided. The film speed was approximately 25 ft/min with a 12% TDO Load master and a 25.4% Load slave, which related to the driving loads of the chains on each side so that the output speeds are synchronized. The graspers used were stainless steel clips. The appearance of all films upon exiting the continuous stretching station was good.

TABLE 1

| | Sample | | | | | | | |
|---|---|---|---|---|---|---|---|---|
| | 3 | 4 | 5 | 6 | 7 | 8 | 9 | 10 |
| % Stretch | 100 | 50 | 25 | 150 | 175 | 200 | 250 | 300 |
| Station 1 | 15.39 | 15.39 | 15.39 | 15.39 | 15.39 | 15.39 | 15.39 | 15.39 |
| Station 2 | 11.00 | 11.00 | 11.00 | 11.50 | 11.50 | 11.50 | 11.50 | 11.50 |
| Station 3 | 15.00 | 15.00 | 15.00 | 15.00 | 15.00 | 15.00 | 15.00 | 15.00 |
| Station 4 | 23.00 | 16.50 | 14.40 | 28.75 | 31.625 | 34.50 | 40.25 | 46.00 |
| Station 5 | 23.00 | 16.50 | 14.40 | 28.75 | 31.625 | 34.50 | 40.25 | 46.00 |
| Station 6 | 23.00 | 16.50 | 14.40 | 28.75 | 31.625 | 34.50 | 40.25 | 46.00 |
| Station 7 | 22.50 | 16.25 | 14.10 | 28.25 | 31.25 | 34.25 | 40.25 | 46.00 |
| TDO Exit | 24.00 | 17.50 | 15.75 | 29.50 | 32.25 | 35.00 | 40.75 | 45.75 |
| Width (in) | | | | | | | | |
| Exit | 2.1-2.5 | 3.1-3.1 | 3.5-4.2 | 1.9-2.5 | 1.7-2.3 | 1.7-2.0 | 1.5-1.8 | — |
| Thickness (mil) | | | | | | | | |

### EXAMPLE 3

In this example, two of the same films used in Example 2 which were grey in color (Samples 11 and 12) were subject to an MDO stretching section. The MDO stretching occurred using a series of rolls. The inlet width was 28 in. (71 cm) with an inlet thickness of 12 mils. The core size was 3 in (6.4 cm). The preheat rollers were operated at a speed of 4 ft/min with no load for Sample 11 and 9 ft/min with a 6% load for Sample 12. The slow drive speed for Sample 11 was 4 ft/min with no load and for Sample 12 it was 9.3 ft/min with 4% load. The fast drive speed, anneal speed and cooling speed for Sample 11 was 8 ft/min with no load. The fast drive speed and anneal speed for Sample 12 were each 14.0 ft/min with a 10% and 6% load respectively. The cooling speed for Sample 12 was 13.3 ft/min with a 3% load. The draw gap setting for Sample 12 was 0.020 in. (0.05 cm). The draw ratio for Sample 11 was 2.0 and for Sample 12 was 1.5. Each sample was run through 7 nip rolls. The pre-heating, slow and fast draw temperatures and annealing temperatures both set point and actual temperatures are shown below in Table 2 in ° F.

TABLE 2

| Roller Series | Sample 11 | Sample 12 |
|---|---|---|
| Preheating #1 Set | 150 | 132 |
| Preheating #1 Actual | 150 | 132 |
| Preheating #2 Set | 150 | 150 |
| Preheating #2 Actual | 151 | 151 |
| Slow Draw Set | 150 | 130 |
| Slow Draw Actual | 150 | 131 |
| Fast Draw Set | 120 | 120 |
| Fast Draw Actual | 121 | 121 |
| Annealing Set | 120 | 100 |
| Annealing Actual | 128 | 113 |
| Cooling Set | 80 | 80 |
| Cooling Actual | 82 | 82 |

Sample 12 after MDO stretching was put through a TDO continuous stretching station with a first zone at 300° F. (300° F. actual) with a 600 rpm fan, a second zone of heating at 300° F. (300° F. actual) with a 600 rpm fan and a third zone at 260° F. (260° F. actual) with a 600 rpm fan. A cooling zone was provided with a 800 rpm fan. The speed through the continuous stretching station was set at 24 ft/min with a TDO load (master) of 10% and load (slave) 13%. The graspers were stainless steel clips. The appearance upon exit was good and appeared grey. The TDO widths at the 7 measuring stations and at the continuous stretching station exit are shown below in Table 3.

TABLE 3

| TDO Station | Width (in) |
|---|---|
| 1 | 13.96 |
| 2 | 11.25 |
| 3 | 11.35 |
| 4 | 22.50 |
| 5 | 22.50 |
| 6 | 22.51 |
| 7 | 21.64 |
| Exit | 22.00 |

The process and apparatus described herein may be varied to provide a wide range of pre-stretched films for use in forming vehicle parts and vehicle part pre-forms. The TDO and MDO stretching may be one separately as individual processes for unidirectional stretching or together for biaxial stretching. This allows the user to maximize what can be done with commercially available paint films. If longer, narrower vehicle parts are to be formed, perhaps it is most beneficial to stretch the film roll along its length using perhaps a narrower roll only in the MDO direction. However, if wider parts are being formed, film usage can be maximized by TDO stretching a wide film to maximize width.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A process for manufacturing a part or a part pre-form, comprising
(a) providing a paint film having a length as measured along a longitudinal axis of the paint film;
(b) continuously stretching the paint film over the length of the paint film to form a pre-stretched paint film; and
(c) applying the pre-stretched paint film to a thermoformable substrate to form a part or part pre-form.

2. The process according to claim 1, wherein the part or part pre-form is a vehicle part or a vehicle part pre-form, respectively.

3. The process according to claim 1, wherein the paint film is continuously stretched in a direction generally perpendicular to the longitudinal axis of the paint film.

4. The process according to claim 3, wherein the paint film is also continuously stretched in a direction generally parallel to the longitudinal axis of the paint film such that the pre-stretched paint film is biaxially stretched.

5. The process according to claim 1, wherein the paint film is continuously stretched in a direction generally parallel to the longitudinal axis of the paint film.

6. The process according to claim 1, wherein the paint film has a width as measured generally perpendicularly to the longitudinal axis of the paint film that is no greater than about 153 cm.

7. The process according to claim 1, wherein the paint film has a thermoformable carrier layer, a decorative layer and a protective layer.

8. The process according to claim 7, wherein the paint film further comprises an adhesive layer on a surface of the thermoformable carrier layer opposite the decorative layer.

9. The process according to claim 7, wherein the decorative layer comprises at least one of a pigment and metallic flakes.

10. The process according to claim 1, further comprising cutting the pre-stretched paint film to a predetermined length as measured along the longitudinal axis of the paint film to form a pre-stretched paint film sheet prior to step (c).

11. The process according to claim 1, wherein the substrate is an extruded sheet and step (c) further comprises continuously applying the pre-stretched paint film to the extruded sheet.

12. The process according to claim 1, wherein the substrate is an extruded sheet and the process further comprises forming a roll of the pre-stretched paint film after step (b) and laminating at least a portion of the roll of the pre-stretched paint film to the extruded sheet.

13. The process according to claim 12, wherein the roll of the pre-stretched paint film is cut to approximate the size of the extruded sheet and then laminated to the extruded sheet.

14. The process according to claim 12, further comprising laminating by application of an adhesive, application of heat and combinations thereof.

15. The process according to claim 1, wherein the pre-stretched paint film and substrate form a vehicle part pre-form and the method further comprises
(d) thermoforming the vehicle part pre-form to form a vehicle part.

16. An article of manufacture, comprising
(a) a thermoformed substrate having a first surface and a second surface; and
(b) a pre-stretched paint film laminated to at least one of the first and the second surface of the thermoformed substrate, wherein the pre-stretched paint film is formed from a paint film having a width as measured generally perpendicularly to a longitudinal axis of the paint film which is no greater than about 153 cm which has been stretched in a direction which is parallel to and/or perpendicular to the longitudinal axis of the paint film so as that it will approximate a size of the thermoformed substrate after thermoforming.

17. The article of manufacture according to claim 16, wherein the paint film is biaxially stretched.

18. The article of manufacture according to claim 16, wherein the article of manufacture is a vehicle part.

19. The article of manufacture according to claim 17, wherein the article of manufacture is a tonneau cover.

20. An article of manufacture, comprising
(a) an extruded sheet capable of forming a part or part pre-form and having a first surface and a second surface; and
(b) a pre-stretched paint film applied to at least one of the first and the second surface of the extruded sheet, wherein the pre-stretched paint film is formed from a paint film having a width as measured generally perpendicularly to a longitudinal axis of the paint film which is no greater than about 153 cm which has been stretched in a direction which is parallel to and/or perpendicular to the longitudinal axis of the paint film so as that it will approximate a size of the extruded sheet.

21. The article of manufacture according to claim 20, wherein the extruded sheet is capable of forming a vehicle part or a vehicle part pre-form.

22. The article of manufacture according to claim 20, wherein the pre-stretched paint film is applied to the extruded sheet by an adhesive.

23. The article of manufacture according to claim 20, wherein the pre-stretched paint film is applied to the extruded sheet by heat lamination.

24. An apparatus for pre-stretching a paint film, comprising
(a) a paint film feed roll;
(b) a continuous stretching station comprising a continuous drive mechanism and a plurality of grippers located on a first side and a second side of the stretching station and which are capable of stretching a paint film in a direction generally perpendicular to a longitudinal axis of a paint film, wherein the continuous drive mechanism activates the plurality of grippers;
(c) a pre-stretched paint film take-up roll; and
(d) at least one heat source.

25. The apparatus according to claim 24, further comprising a tensioner capable of stretching a paint film in direction along a longitudinal axis of a paint film.

26. The apparatus according to claim 25, wherein the tensioner comprises the paint film feed roll and the pre-stretched film take-up roll operating at different speeds so as to create tension.

27. The apparatus according to claim 24, wherein the apparatus further comprises an extruder for forming an extruded sheet and an application station for directly applying the pre-stretched pre-stretched paint film from the take-up roll to an extruded sheet from the extruder.

28. The apparatus according to claim 24, wherein the continuous drive mechanism comprises a chain drive on each of the first side and the second side of the stretching station which chain drives diverge from each other at an exit side of the stretching station.
